(19) United States
(12) Patent Application Publication
(10) Pub. No.: US 2015/0169139 A1
(43) Pub. Date: Jun. 18, 2015

(54) Visual Mapping Based Social Networking Application

(71) Applicants: Darren Leva, San Francisco, CA (US); Paul Mennega, Toronto (CA)

(72) Inventors: Darren Leva, San Francisco, CA (US); Paul Mennega, Toronto (CA)

(21) Appl. No.: 14/453,580

(22) Filed: Aug. 6, 2014

Related U.S. Application Data
(60) Provisional application No. 61/863,866, filed on Aug. 8, 2013.

(51) Int. Cl. G06F 3/0481

(52) U.S. Cl. CPC G06F 3/0481; G06F 2203/04806

(57) ABSTRACT

The disclosure is directed to a group management application that provides various social networking features, including finding people, sharing content, providing introductions, visually representing users on a geographical map. Users are mapped based on their home and/or work addresses. The content they post is posted in list form and posted directly to the map, creating a visual representation of a specific group of users and the opportunities that they post. The geographical map visually represents the users as “heat circles,” which indicates a presence of number of users in a particular geographical location, or as icons, which represents individual users located in the particular geographical location. The group management application represents the users as heat circles or as icons based on the size and zoom level of the geographical map.

### CLAIM OF PRIORITY

This application claims priority to U.S. Provisional Application No. 61/863,866, filed on Aug. 8, 2013.

### BACKGROUND

Current social networking applications allow users to connect with other users and share content with other users. Each of the social networking applications provides a varied set of features. For example, one type of social networking applications allow users to share content such as status post, a comment or images with other users. Some social networking applications allow users to connect with each other for professional networking. Some social networking applications allow the users to form groups to share content related to specific interests. However, the current social networking applications lack capabilities for integrating one another to provide an integrated set of features.

Further, the current social networking applications represent users of the social networking application in a non-graphical way. For example, the users are displayed as a list. Also, some of the social networking applications display only the friends/connections/followers of a user and a limited set of users who are not friends/connections/followers. Such non-graphical way of representing users is typically not convenient for finding new users to make new connections with. Accordingly, the users may not be able to use the social networking applications to their full potential and the intention of the social networking applications—building a result oriented social network that allows the users to benefit from sharing information within social network, may not be realized.

### BRIEF DESCRIPTION OF THE DRAWINGS

FIG. 1 is a block diagram illustrating an environment in which a group management application can be implemented.

FIG. 2 is an example of a geographical map that displays heat circles indicating presence of users at one or more geographical locations.

FIG. 3 is another example of a geographical map that displays heat circles indicating presence of users at one or more geographical locations.

FIG. 4 is an example of a geographical map that displays icons representing individual users at a particular geographical location.

FIG. 5 is an example graphical user interface (GUI) of the group management application for displaying information regarding users displayed in a geographical map.

FIG. 6 is a flow diagram of a process for visually representing groups of users in a geographical map.

FIG. 7 is a flow diagram of a process for importing user data to the group management application from a client system.

FIG. 8 is a block diagram of a computer system as may be used to implement features of some embodiments.

### DETAILED DESCRIPTION

The disclosed embodiments are directed to a group management application that provides various social networking features, including finding people, sharing content, providing introductions, visually presenting users of the group management application on a geographical map, etc. The group management application also includes techniques for searching users with a common attribute between two or more users within a specific interest group, team or any organization/corporation. The group management can be implemented in various configurations, e.g., as a website, an application that can be downloaded to a user device and executed, also referred to as a “group management app.” The group management application can be accessed using a number of user devices, e.g., a smartphone, a tablet PC, a desktop, a laptop, a computer installed in an automobile etc. The group management application can be used by any type of users, e.g., an organization, a specific team in an organization, a closed group users or other users.

The group management application can also visually represent the users on a geographical map. The group management application can use a variety of geographical maps such as Google Maps or open source maps such as Mapbox. In some embodiments, the group management application is visually based on mapping of people and content. People are mapped based on their home and/or work locations, separated by icons. The content they post is posted in list form and posted directly to the map, creating a visual representation of a specific group of people and the opportunities that they post.

In some embodiments, the users are visually represented in a geographical map “heat circles.” A heat circle indicates the presence of users in a particular geographical location. In some embodiments, the heat circle indicates the presence of users in the particular geographical location who have a common attribute, e.g., users belonging to a specific interest group such as vegan cooking, users employed in a particular organization, etc. The group management application employs a clustering technique that can cluster large volumes of map-based content into the heat circles (or other visual clusters) or graphical representation of individual users based on size and zoom level on a map.

The clustering technique obtains locations of the users, e.g., from a database which contains user information, clusters the users based on the location information and creates a heat circle with a number representing the number of users in a specific location. When the user zooms into the map and/or when the user selects, e.g., clicks, heat circle, the map is zoomed into and the heat circle is split into two or more heat circles based on the zoom level. The zooming in on the map changes the heat circle cluster sizes and the number the heat circle displays until the map is zoomed far enough, e.g., to a particular zoom level, to present a graphical representation of individual users, e.g., icons, in a particular geographical location. When the map is zoomed in to the particular zoom level, the group management application executes a geocoding script that geocodes the location information of the users located in the particular geographical location to generate geocoded addresses of the users and displays the icons of the users in the map based on the geocoded addresses. When the zoom level reaches the particular zoom level, the heat circle disintegrates into the constituent users of the heat circle.

In some embodiments, the geocoding script is not executed until the zoom level reaches the particular zoom level. The icons are geocoded in real time through various application programming interface (API) connections to geocoding services. In some embodiments, the geocoding script is executed depending on location or verification of a valid address and/or once the zoom level is close enough to see metro areas as opposed to geocoding location information of all the users at once, thereby reducing consumption of computing resources. In some embodiments, displaying icons of the users at a low zoom level, e.g., a zoom level at which an entire country or a state is visible, may generate a significantly high number of icons as there can be a number of users in the entire country or state, which may not be very helpful for a user as it is inconvenient to browse through a selected set of users. Accordingly, the presentation of icons of users is restricted to a particular zoom level, which therefore, allows the execution of the geocoding script to be put off until the particular zoom level is reached.

The icons are geocoded and the information in each icon about an individual or posting, is then loaded, e.g., from a database of the group management application in real time. In some embodiments, additional information may be displayed in a pop up window related to the user associated with a particular icon. The group management application obtains information from the database, a third party database, database of a client, e.g., organization using the group management application etc. The group management application stores the information obtained from the client's database in the database of the group management application. This allows for a very large number of icons to be utilized on one map while making it highly usable for the end user to find people, opportunities, plan events, or locate content in their specific local.

In some embodiments, the pop-up window for each user icon includes a connection to a third party social networking application, e.g., Linkedln, Twitter, Facebook, Dropbox, Salesforce.com, Zoho, Filemaker, Raiser's Edge. The group management application uses existing social media platform APIs to obtain data about the user from the third party applications into the group management application. As an example, a user can connect their existing Linkedln account to their user profile in the group management application, and the popup window can display the user's picture, and other data from their LinkedIn profile. The link to the third party social networking application can be utilized for any platform with APIs and any individual can attach their existing social media accounts which synchronize with the group management application, onto the geographical map. The group management application can obtain information associated with a user from multiple sources and display seamlessly to the end user.

The group management application can be used for fundraising, event planning/management, career networking, personal networking, volunteer management, group management and communication, notifying/selling/alerting users of content/opportunities. In some embodiments, the group management application is a combination of mapping, searching, social media integration, content posting alone and directly to the map, API geocoding, API address verification, API database integration, algorithms, secure login, mobile access, API integrations using comma separated values (CSV) file and/or multiple platforms such as LinkedIn, Twitter, Facebook, Dropbox, Salesforce.com, Zoho, Filemaker, Raiser's Edge.

The group management application can be implemented as a cloud service and with SSL encryption. The group management application can be completely private for a client, e.g., a group or organization, and can be integrated with their database, e.g., to obtain user information, in many ways. For example, the database can be integrated with the group management application via APIs of the client's database, or via CSV file, e.g., through a shared Dropbox account. The Dropbox account or the client database can be synchronized with the group management application on a specified schedule or based on other trigger conditions, e.g., addition of a new user to the client's database, manually by an administrator.

In some embodiments, the client databases can be published to the group management application as read-only databases. That is, the group management application can only read the data from the client database and not write to the client database. The user data obtained from the client database can include various information associated with the user, e.g., a name of the user (first, middle and last), a title of the user, a name of the organization where the user is employed, year of graduation, work address, home address, telephone number(s), email address(es), or any other content customizable based on the clients requirements. Some the user data can be mandatory. For example, the name of the user, the work address and email address can be mandatory. The user data can be used to create automatic user accounts with the group management application. The user accounts can be created based on membership data and can have email address as the unique qualifier and login username.

In some embodiments, the client databases can be published to the group management application as read-write databases. Users can update their user profile and the updates can be pushed to the client databases. The group management application can be setup to write to the client's database. In some embodiments, an administrator at the client side may have to approve before the updates are applied to the client database. For example, the user updates personal information on the group management application, the administrator on the client side can view the update on an admin screen and approve/disapprove new content. Clients also have the option of having members send updates via email instead of through direct API connection to their database.

The geographical map of the group management application has a search functionality that is directly associated with mapping heat circles. A search bar with customizable filters can be used to search for heat circles and/or users and display in the map. In some embodiments, a search for a specific term will search all profile information and will display a re-calibrated visual appearance of heat circle. Search filters can be added to the search or used alone to find groups of people or individuals by location, within the larger organization. The search results can be displayed as a list and the list can be scrolled through. When an individual or posting is selected in the list of search results, the map moves to that icon associated with the user and opens the pop-up window and displays information.

The group management application allows any users to post content or allows for administrators of the client to customize posting categories and permissions for each category (public vs. admin only posting). The group management application includes community moderation through “flagging” of undesirable listings, IHSS feeds, bookmarking capabilities and visual gee-display of postings on the map, overlaid with other mapped icons. In some embodiments, the content posted in the group management application by a user can be sent to each user's email address. In some embodiments, the posting can be reported to the user based on client specific rules and policies. For example, the posting can be pushed as a weekly digest email of new content posted. The group management application also has email confirmation included. When a new posting is submitted in the group management application, the user would receive an email, they can confirm that they own the email account and accept the posting. The posting can then be posted to the group management application. If the posting expires, the group management application automatically generates an email alerting the user and allows them to repost if they desire.

The group management application includes an introductions feature that introduces one user to another user based on a match between the two users. The group management application determines a score for a pair of users as a function of various user information, e.g., a location (home address and/or work address), career commonalities, industry, title, role, job level, year of graduation, age, major and any other data provided by the client. The higher the score the higher the match. The scores can be calculated on specified schedule, e.g., once a month. Each email address in the group management application can receive an automated introduction to another person, based on the score. In some embodiments, the introductions feature based on the scoring simulates an online version of “real-world” human connections. The introductions feature is designed to automatically introduce two people belonging to a common group based on location and other commonalities, which could result in meaningful impact to their lives. The scoring can repeat on a cycle that can be controlled by the user. The group management application also includes automatic emails to remind new users to register for the introductions feature.

The group management application also includes administration tools to help the administrator manage the group. This includes access to “dashboards” of statistics and metrics generated by activities on the group management application, including logins, clicks, registrations, social media connections or any customizable data point desired by a client. The group management application also facilitates the administrators to prevent a user from being able to login to the group management application, hide a user's profile so it's not searchable by other users, or make another user an administrator, The administrator can also create non-map based searches and use those search results to populate an email form for mass emailing from within the group management application. For example, the administrator can search for users by a geographical location and use those search results to populate an email form for mass emailing to those users. The group management application also facilitates ad-hoc communications to specific groups within the group with large datasets. The administrator can deem another user a “moderator” and give the user access to mass email only, empowering the user to communicate on behalf of the organization.

The group management application also provides various map related tool for administrators. For example, the group management application includes a “shape tool”, e.g., like a re-sizable box, that an administrator can use to select an area on the geographical map. After the area is selected, the administrator can obtain a list of users located in the selected area and can perform a number of operations on the obtained users. For example, the administrator can instantly email, text, invite, or push notifications to mobile group management application app, to the obtained users. Another tool, e.g., a selection tool calculates the map coordinates and includes all of the icons on the map that are within the coordinates. It then generates a report for email addresses, phone numbers, etc. and synchronizes with the email tool or other tool to accomplish the communication. These tools enable visual selection and communication simply by geographical location. This can be combined with search and filter functionality.

### Environment

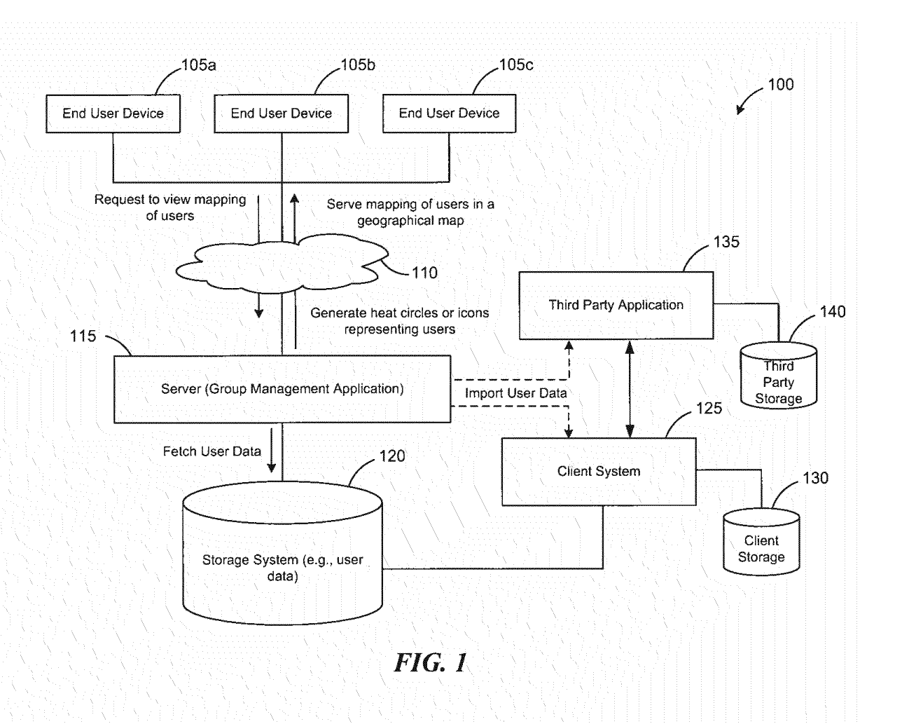

FIG. 1 is a block diagram illustrating an environment (“environment”) 100 in which the above group management application can be implemented. The environment 100 includes a group management server 115 that facilitates management of groups of users via the group management application. For example, the group management application can be used by employees of an organization, people with common interests, etc. to perform group activities like sharing content, posting opportunities, etc. The group management application can be implemented in various configurations. For example, the group management application can be implemented as a web application, which can be accessed by end users via a website of the group management application. In another example, the group management application can be implemented as an application (“app”), which can be downloaded onto the end user device such as end user device 105a of end user devices 105a-c.

The server 115 can execute the group management application, e.g., at least a portion of the group management application. For example, if the group management application is implemented as a mobile app, a portion of the group management application can execute on an end user device such as end user device 105a and another portion can execute at the server 115. Each of the end user devices 105a-c can be any of a smartphone, a tablet PC, a desktop, a laptop, a computing device integrated in an automobile, a wearable gadget, or any other computing device capable of executing the group management application. The end user devices 105a-c can communicate with the server 115 via a communication network 110, which can include a wide area network (WAN), a local area network (LAN), Internet, etc.

The environment 100 includes a storage system 120 where the group management application stores various types of data that may be required for executing the group management application. For example, the storage system 120 can include user information such as user profile data or postings posted by the users, application components such as a downloadable executable file of the group management application to be installed on the end user device 150a-c, the geocoding scripts etc. The storage system 120 can be implemented as a database, a file etc. The storage system 120 can be stored at a storage medium such as a hard drive, a magnetic tape, a solid state drive, a cloud storage service, etc. In some embodiments, some of the data e.g., user data, can be imported to the storage system 120 from other systems such as a client system 125, e.g., a computing system associated with an organization, that is consuming the group management application. The client system 125 can store the user information at a client storage 130 associated with the client system 125. In some embodiments, some of the data e.g., user data, can be imported to the storage system 120 from a third party application 135 such as a social networking application, e.g., Facebook. The third party application 135 can store the user information at a third party storage 140 associated with the third party application 135.

The third party application 135 can be an application such as LinkedIn, Twitter, Facebook, Dropbox, Salesforce.com, Zoho, Filemaker, Raiser's Edge. The server 115 can obtain the data from the client system 125 or the third party application via APIs provided by the respective systems, via CSV file, e.g., through a shared Dropbox account.

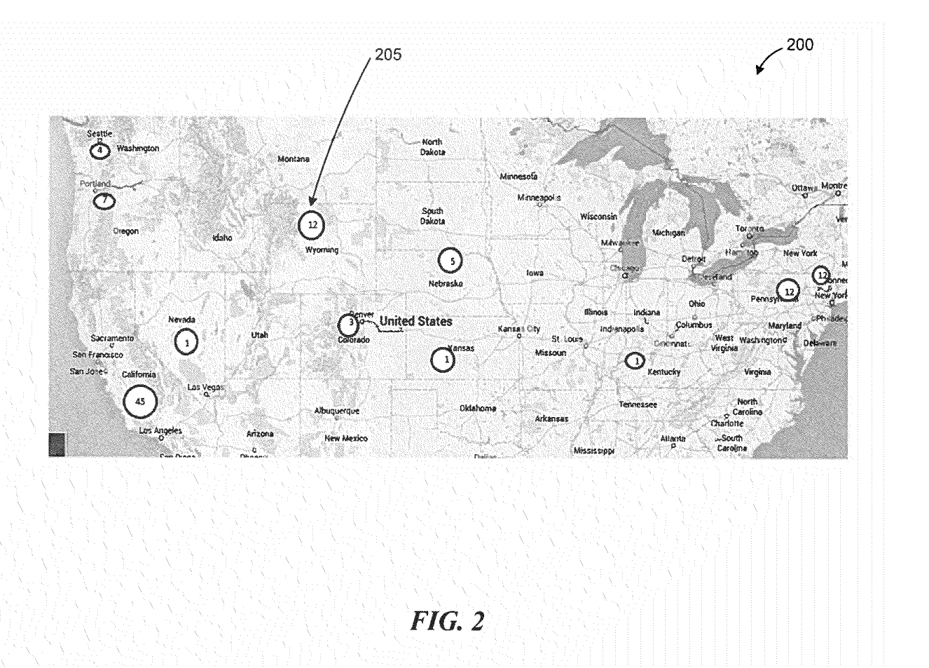

In some embodiments, the group management server 115 facilitates visual representation of a group of users on a geographical map such as geographical map 200 of FIG. 2. The geographical map 200 can be viewed on an end user device such as end user device 105a. When the end user device 105a requests to view a mapping of the users, the group management server 115 determines a zoom level of the geographical map 200 displayed on the end user device 105a, determines a set of the geographical locations displayed in the geographical map 200 at the zoom level, and obtains the list of users who are located in the set of geographical locations. In some embodiments, the group management server 115 obtains the users located in the set of geographical locations based on the work address or home address of the users.

The group management server 115 determines if the zoom level is at a specified threshold for displaying individual users located in the set of geographical locations on the geographical map 200. If the zoom level is not at the specified threshold, the group management server 115 generates heat circles such as the heat circle 205 clustering the users at each of the set of geographical locations. The heat circle indicates a presence of a group of users at a particular location. In some embodiments, the heat circle also displays a number of the users present at the location. For example, the heat circle 205 indicates a presence of twelve (“12”) users in the state of Wyoming.

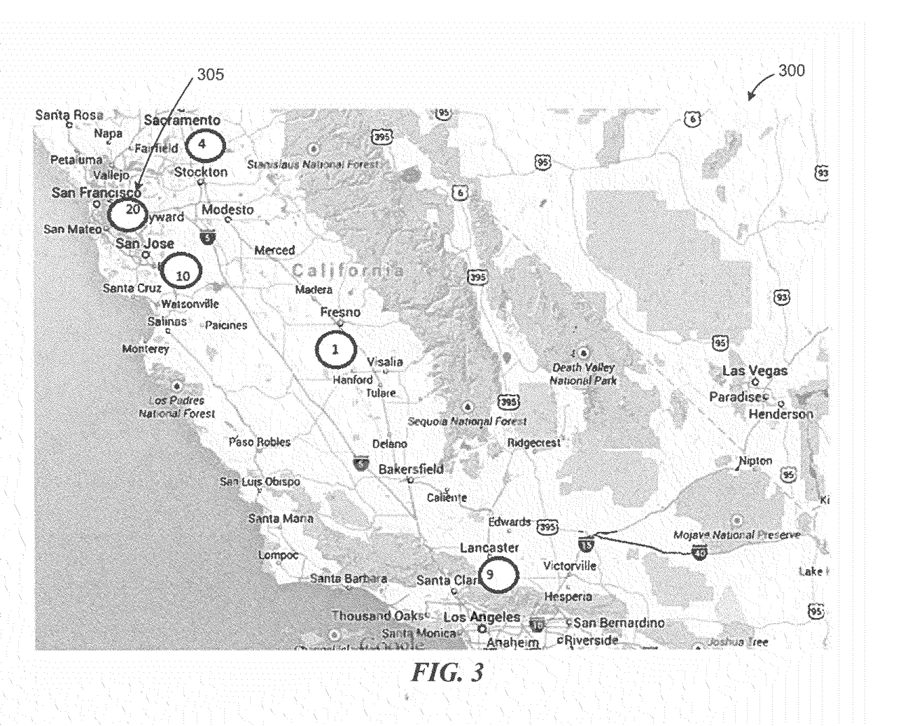

In some embodiments, the number of heat circles displayed in the geographical map 200 depends on a zoom level of the map. For example, if the zoom level is such that an entire country is visible, the group management server 115 can generate heat circles in each of the states of the country where users are located, as in geographical map 200. In some embodiments, if the zoom level is such that a portion of the country, e.g., one or more states, is visible, then a heat circle for a state may be split into two or more heat circles representing users located at specific regions of the state, e.g., cities. For example, a geographical map 300 of FIG. 3 displays a portion of the state California and a portion of the state Nevada. The group management server 115 splits the heat circle in California into five heat circles, such as the heat circle 305, over five cities indicating presence of users of the group management application at the five cities. For example, the heat circle 305 indicates the presence of the users at the city of San Francisco. In some embodiments, a user associated with the end user device 105a may arrive at the geographical map 300 by zooming in the geographical map 200 and repositioning the zoomed map to California as in the geographical map 300.

In some embodiments, the number of heat circles displayed in the geographical map also depends on a size of the geographical map displayed in the end user device 105a. If the size of the geographical map rendered on the end user device 105a is of a smaller size than the geographical map 200, then one or more heat circles displayed in the geographical map 200 may be combined to one heat circle and the combined heat circle represents the users at the geographical locations corresponding to the combined heat circles.

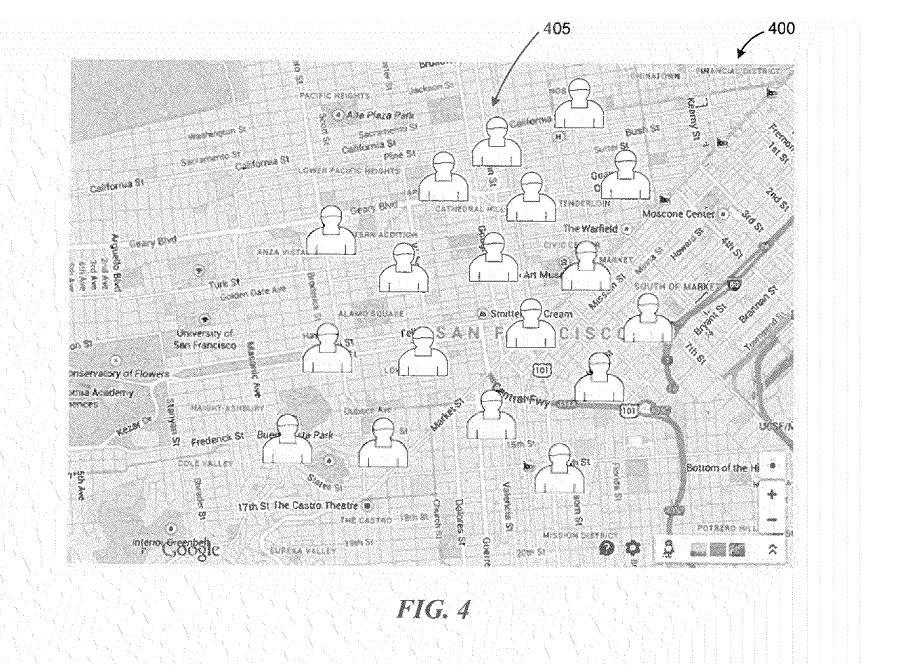

If the geographical map is zoomed to the specified zoom level, the heat circle disintegrates to one or more icons representing individual users at a particular geographical location. In some embodiments, an administrator of the group management server 115 or even a user associated with the end user device 105a can set the threshold for the specified zoom level to display the individual users. For example, the specified zoom level can be set to the city level, a portion of the city level, street level, specified feet above the ground level such as 300 feet, 500 feet, etc. FIG. 4 is an example of a geographical map 400 that displays icons representing individual users at a particular geographical location. In the FIG. 4, the geographical map 400 is zoomed to the city level. The group management server 115 determines that the zoom level of the geographical map 400 is at the specified level and the group management server 115 splits the heat circle for city of San Francisco to individual users and the geographical map 400 displays the icons associated with the individual users, such as icon 405, as illustrated in FIG. 4.

The heat circles and the icons illustrated in FIGS. 3-5, are examples only. The group management server 115 can display the group of users and/or individual users using other graphical representations. For example, the heat circles can be represented using other graphical representations such as triangles, squares, etc. In another example, the individual users can be represented using user defined avatars, which are images, cartoons, sketches, etc. representing the users.

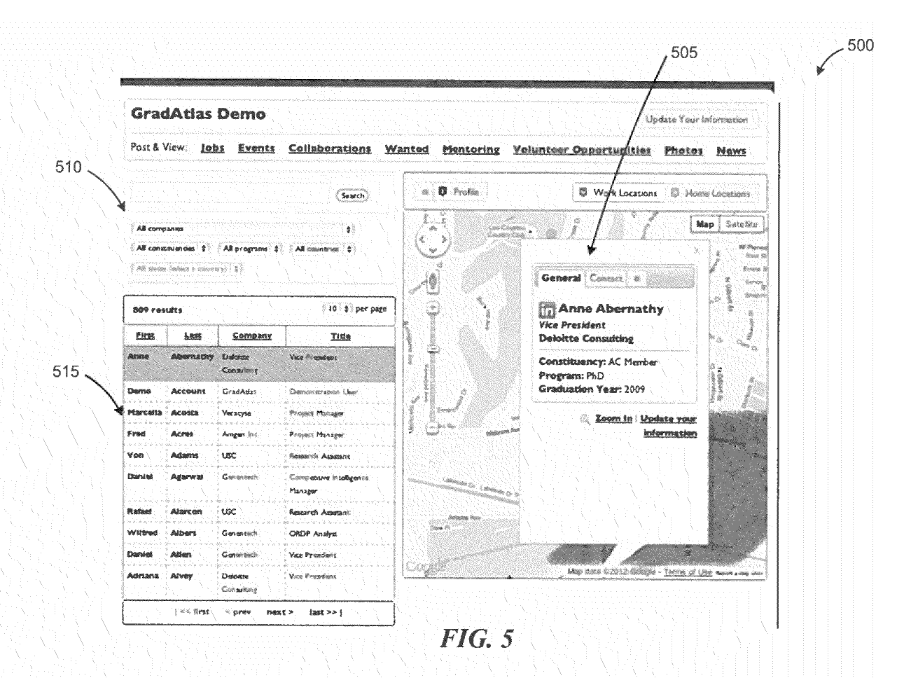

Information regarding the users displayed in the geographical map 400 can be viewed by selecting an icon corresponding to the user. For example, information regarding the user associated with icon 405 can be viewed by selecting the icon 405. FIG. 5 is an example graphical user interface (GUI) 500 of the group management application for displaying information regarding users displayed in a geographical map. The GUI 500 displays information regarding the user associated with icon 405 in a pop-up window 505. The information can be a user profile associated with the user including name, address, contact numbers, a posting shared by the user, information associated with the user obtained from the third party application 135, etc. In some embodiments, a posting can include multimedia content such as text, an image, an audio clip, a video clip, etc.

In some embodiments, the GUI 500 also displays the users at a particular geographical location as a list, e.g., list 515. The GUI 500 also includes a search tool 510 that allows an end user to search for users in the group management application. The search tool 510 also includes various search filters to customize the search. For example, the search tool 510 allows searching for users by organization where the users are employed, country and/or state where the users are residing or working, etc. In another example, the search tool 510 allows searching for users by a geographical location.

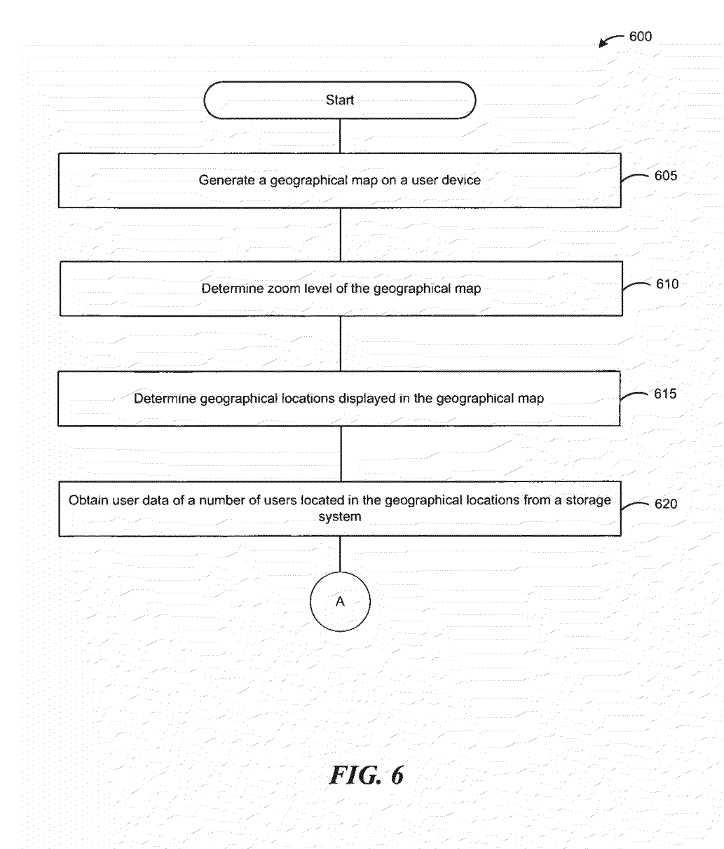

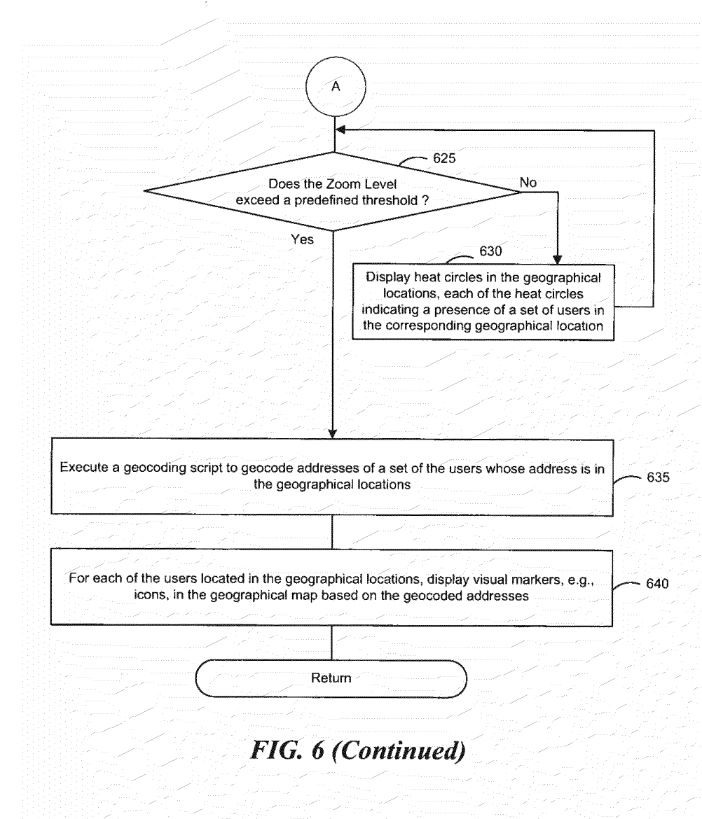

FIG. 6 is a flow diagram of a process 600 for visually representing groups of users in a geographical map. The process 600 can be executed in the environment 100 of FIG. 1. In some embodiments, the group management application can be consumed by users such as employees of an organization. At block 605, the group management server 115 generates a geographical map on a user device of an end user. The geographical map can be a variety of geographical maps such as Google Maps or open source maps such as Mapbox. In some embodiments, the geographical map is rendered on the user device when the end user accesses the geographical map feature of the group management application.

At block 610, the group management server 115 determines the zoom level of the geographical map. At block 615, the group management server 115 determines a set of geographical locations displayed in the geographical map. At block 620, the group management server 115 obtains the set of users located in the set of geographical locations. In some embodiments, the group management server 115 identifies the set of users whose location, e.g., home address and/or work address, are in the set of geographical locations. The users' location can be stored as part of user information in the storage system associated with the group management server 115. In some embodiments, the user information is imported to the storage system from the organization database.

At determination block 625, the group management server 115 determines whether the zoom level of the geographical map exceeds a specified threshold for displaying the users individually on the geographical map. In some embodiments, the specified threshold is also a function of the size of the geographical map rendered on the end user device. Responsive to a determination that the zoom level does not exceed the specified threshold, at block 630, the group management server 115 generates one or more heat circles in the geographical map at one or more of the set of geographical locations. Each of the heat circles indicates a presence of one or more users at the corresponding geographical location. In some embodiments, the heat circle also displays a number of the users present at the corresponding geographical location. The process 600 returns to block 625.

Responsive to a determination that the zoom level exceeds the specified threshold, at block 635, the group management server 115 executes a geocoding script to geocode the addresses of the users located in the set of geographical locations. In some embodiments, geocoding is a process where a street address is converted to a longitude/latitude coordinate. After the addresses of the users are geocoded, at block 640, the group management server 115 displays a visual marker, e.g., an icon such as the icon 405, for each of the users located in the set of geographical locations, and the process 600 returns.

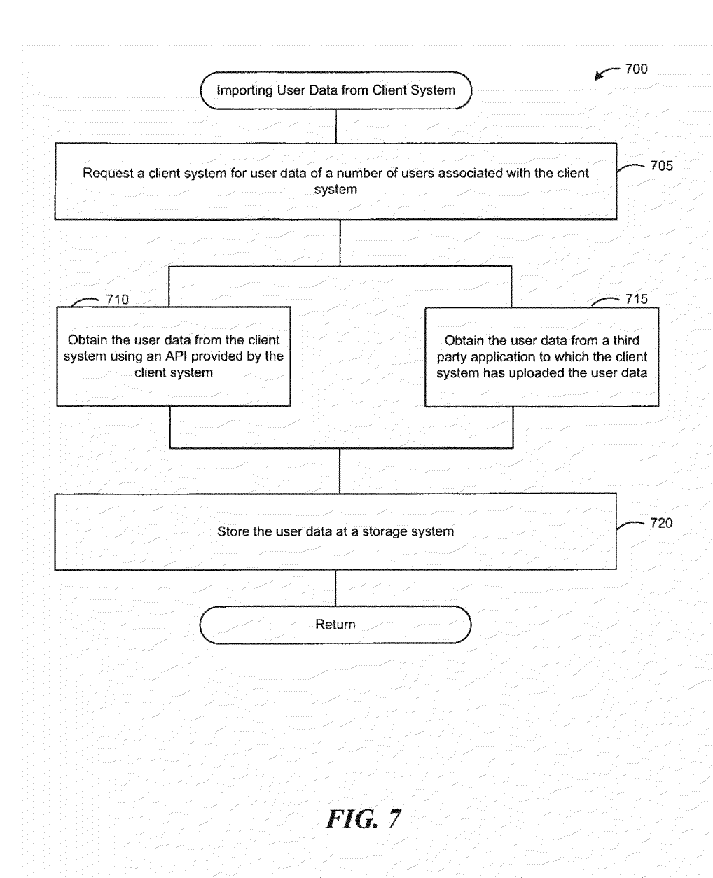

FIG. 7 is a flow diagram of a process 700 for importing user data to the group management application from a client system. The process 700 can be executed in the environment 100 of FIG. 1. In some embodiments, the group management application can be consumed by a client, e.g., an organization. At block 705, the group management server 115 requests the client system, e.g., a computing system associated with the organization, for the user data of a number of users associated with the client system, e.g., employees of the organization. The group management server 115 obtains the user data in number of ways. For example, the group management server 115 can obtain the user data from the client system via the APIs published by the client's database or via CSV file (block 710). Additionally or alternatively, the group management server 115 can obtain the user data from a third party application, e.g., Dropbox, to which the client system has uploaded the user data (block 715).

At block 720, the group management server 115 stores the user data at a storage system associated with the group management server, e.g., storage system 120. In some embodiments, the group management server 115 synchronizes with the client system to obtain the user data based on a specified schedule.

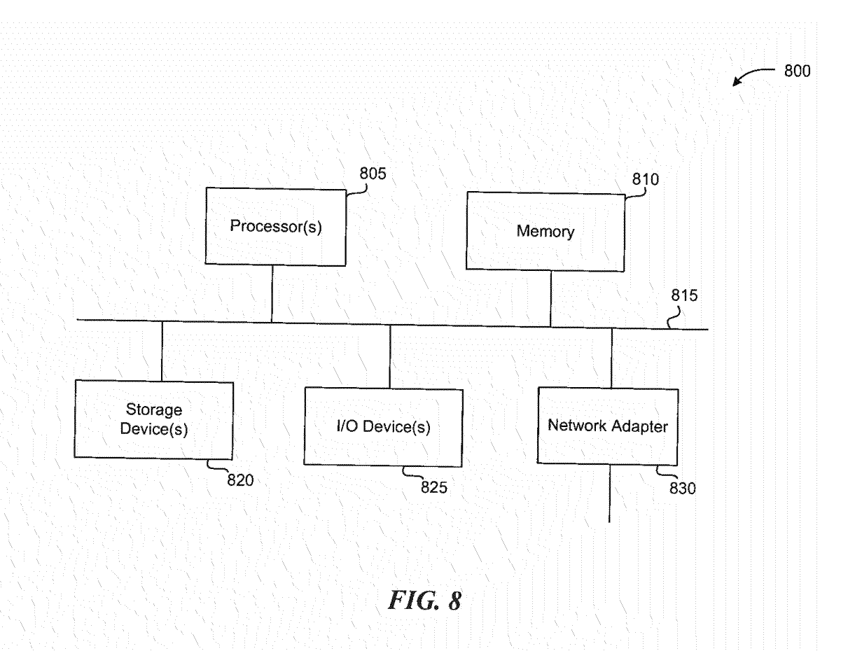

FIG. 8 is a block diagram of a computer system as may be used to implement features of some embodiments of the disclosed technology. The computing system 800 may be used to implement any of the entities, components or services depicted in the examples of FIGS. 1-7 (and any other components described in this specification). The computing system 800 may include one or more central processing units (“processors”) 805, memory 810, input/output devices 825 (e,g., keyboard and pointing devices, display devices), storage devices 820 (e.g,, disk drives), and network adapters 830 (e.g., network interfaces) that are connected to an interconnect 815. The interconnect 815 is illustrated as an abstraction that represents any one or more separate physical buses, point to point connections, or both connected by appropriate bridges, adapters, or controllers. The interconnect 815, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 810 and storage devices 820 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 810 can be implemented as software and/or firmware to program the processor(s) 805 to carry out actions described above. In some embodiments, such software or firmware may be initially provided to the processing system 800 by downloading it from a remote system through the computing system 800 (e.g., via network adapter 830).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A method performed by a computing system, comprising:
generating, by a mapping application executing on the computing system, a geographical map on a user device;
determining a zoom level of the geographical map, the zoom level determining a plurality of geographical locations displayed in the geographical map; and
generating a plurality of heat circles in the geographical map across a set of the geographical locations, each of the heat circles representing a first set of a plurality of users of the mapping application located in the corresponding geographical location of the set of geographical locations.

2. The method of claim 1 further comprising:
increasing, in response to a user interaction, the zoom level of the geographical map to a first zoom level, the first zoom level causing the geographical map to display a second set of geographical locations;
determining whether the first zoom level exceeds a predetermined threshold; and
responsive to a determination that the first zoom level exceeds a predetermined threshold, generating a plurality of visual indicators across the second set of geographical locations displayed in the geographical map, each visual indicator representing a user of a second set of the users whose address corresponds to one of the second set of geographical locations.

3. The method of claim 2 further comprising:
responsive to a determination that the first zoom level does not exceed the predetermined threshold, generating a second plurality of heat circles in the geographical map across the second set of geographical locations, each of the second plurality of heat circles representing a presence of a second set of the users located in the second set of geographical locations.

4. The method of claim 2, wherein generating the plurality of visual indicators across the second set of geographical locations includes:
executing a geocoding script to geocode addresses of the second set of the users to generate a set of geocoded addresses of the second set of the users, and
displaying the plurality of visual indicators in the geographical map based on the set of geocoded addresses.

5. The method of claim 2 further comprising:
displaying (a) content posted by the user to the mapping application and (b) content shared with the user by one or more of the users.

6. The method of claim 2 further comprising:
obtaining information regarding the user from one or more third party social networking applications, the information including user profile of the user and content associated with the user in the one or more third party social networking applications; and
displaying the information of the user in association with the geographical map.

7. The method of claim 1 further comprising:
determining a match between two users of the users based on a plurality of parameters from a user profile of the two users;
determining a score for the two users based on the match; and
if the score exceeds a predetermined threshold, sending an introduction message to the two users, the introduction message introducing a user of the two users to the other of the two users.

8. The method of claim 7, wherein the parameters from the user profiles of the two users include a home address, a work address, and common interests of the two users.

9. The method of claim 1, wherein the users are associated with a client computing system, and wherein generating the heat circles includes:
obtaining, by the mapping application, user profile of each of the users from a client computing system, the user profile including an address of a location of each of the users.

10. The method of claim 9, wherein obtaining the user profile of each of the users from the client computing system includes obtaining the user profile using an application programming interface (API) provided by the client computing system.

11. The method of claim 9, wherein obtaining the user profile of each of the users from the client computing system includes obtaining the user data from a third party application to which the client computing system has uploaded the user data.

12. The method of claim 9, wherein the address of each of the users is at least one of a work address or home address of the corresponding user.

13. The method of claim 9, wherein obtaining the user data further includes obtaining a name and an email address of each of the users.

14. The method of claim 9 further comprising:
generating, by the mapping application, a user account for each of the users using one of a plurality of data items from the user data as a unique identification (ID) of the corresponding user.

15. The method of claim 14, wherein the unique ID is an email address of the corresponding user.

16. The method of claim 1, wherein generating the heat circles includes:
indicating, in each of the heat circles, a number of the users in the first set of the users located in the corresponding geographical location.

17. A computer-readable storage medium comprising instructions, which when executed by a processor performs a method of:
generating, by a mapping application executing on the computing system, a geographical map on a user device, the mapping application configured to represent a plurality of users of the mapping application on the geographical map as a plurality of visual indicators or a plurality of heat circles;
determining a zoom level of the geographical map, the zoom level determining a plurality of geographical locations to be displayed in the geographical map;
if the zoom level is below a predetermined threshold, generating the heat circles in the geographical map across a set of the geographical locations displayed in the geographical map, each of the heat circles representing a first subset of the users located in the corresponding geographical location of the set of geographical locations; and
if the zoom level exceeds a predetermined threshold,
executing a geocoding script to generate a set of geocoded addresses of a second subset of the users located in a second set of geographical locations displayed in the geographical map, and
displaying a set of the visual indicators corresponding to the second subset of the users in the geographical map based on the set of geocoded addresses, each of the set of visual indicators representing a user of a second subset of the users whose address is in one of the second set of geographical locations.

18. The computer-readable storage medium of claim 17 further comprising instructions, which when executed by the processor, perform the method of:
generating a graphical user interface (GUI) for facilitating the users to search for other users based one or more user data.

19. The computer-readable storage medium of claim 17, wherein the users of the mapping application share a common relationship.

20. A system, comprising:
a processor;
a memory having instructions, which when executed by the processor, performs the method of:
generating, by a mapping application executing on the computing system, a geographical map on a user device, the mapping application configured to represent a plurality of users of the mapping application on the geographical map as a plurality of visual indicators or a plurality of heat circles;
determining a zoom level of the geographical map, the zoom level determining a plurality of geographical locations to be displayed in the geographical map;
if the zoom level is below a predetermined threshold, generating the heat circles in the geographical map across a set of the geographical locations displayed in the geographical map, each of the heat circles representing a first subset of the users located in the corresponding geographical location of the set of geographical locations; and
if the zoom level exceeds a predetermined threshold,
executing a geocoding script to generate a set of geocoded addresses of a second subset of the users located in a second set of geographical locations displayed in the geographical map, and
displaying a set of the visual indicators corresponding to the second subset of the users in the geographical map based on the set of geocoded addresses, each of the set of visual indicators representing a user of a second subset of the users whose address is in one of the second set of geographical locations.
